(19) United States
(12) Patent Application Publication
(10) Pub. No.: US 2026/0302163 A1
(43) Pub. Date: Oct. 1, 2026

(54) SECONDARY BATTERY, SECONDARY BATTERY MODULE, VEHICLE, AND METHOD OF MANUFACTURING SECONDARY BATTERY

(71) Applicant: HONDA MOTOR CO., LTD., Tokyo (JP)

(72) Inventors: Kizashi IWAKIRI, Saitama (JP); Masahiro HOKAZONO, Saitama (JP); Fumikazu NAKAZAWA, Saitama (JP); Hideki MATSUDA, Saitama (JP); Yuta KAGEI, Saitama (JP); Keigo HOIZUMI, Saitama (JP); Shigeyuki KOBAYASHI, Saitama (JP); Kyoka ITASAKA, Saitama (JP)

(21) Appl. No.: 19/578,875

(22) Filed: Mar. 26, 2026

(30) Foreign Application Priority Data
Mar. 31, 2025 (JP) 2025-060159

(51) Int. Cl. H01M 4/13; H01M 4/04; H01M 4/134; H01M 4/139; H01M 4/62; H01M 4/02

(52) U.S. Cl. CPC H01M 4/13; H01M 4/0402; H01M 4/134; H01M 4/139; H01M 4/62; H01M 2004/021; H01M 2220/20

(57) ABSTRACT

Provided is a secondary battery having improved safety. The secondary battery includes a multilayer body, a negative electrode tab and a positive electrode tab respectively extending from the negative electrode current collector layer and the positive electrode current collector layer in an X direction that is orthogonal to the stacking direction of the multilayer body, a covering layer being disposed at, from among outer edges of the insulating member in a direction orthogonal to the stacking direction, at least one outer edge in a Z direction that is orthogonal to the X direction, and a length in the X direction of the covering layer disposed on one side in the Z direction being disposed to be longer than a length of the negative electrode layer in the X direction and to include, in the X direction, both ends of the negative electrode layer in the X direction.

This application is based on and claims the benefit of priority from Japanese Patent Application No. 2025-060159, filed on 31 Mar. 2025, the content of which is incorporated herein by reference.

### BACKGROUND OF THE INVENTION

### Field of the Invention

The present invention pertains to a secondary battery, a secondary battery module, a vehicle, and a method of manufacturing a secondary battery.

### Related Art

In recent years, research and development pertaining to secondary batteries that contribute to improving energy efficiency has been carried out in order to be able to ensure access to sustainable and advanced energy that is affordable and can be trusted by many people.

As such a secondary battery, a secondary battery in which a solid electrolyte layer is disposed between a positive electrode layer and a negative electrode layer is known. A lithium metal battery that has at least one of lithium metal or a lithium alloy as a negative electrode active material is known as a secondary battery. For such a secondary battery, a technique for covering an outer edge of the positive electrode layer with an insulating material in order to improve insulation properties between the positive electrode layer and the negative electrode layer is known.

Patent Document 1: Japanese Unexamined Patent Application, Publication No. 2022-136742

### SUMMARY OF THE INVENTION

Patent Document 1 discloses, as a technique for manufacturing a power storage device, a technique for forming a resin layer made from a cured product of a resin on at least one side surface from among each side surface on the long sides and short sides at the perimeter of top and bottom surfaces when two rectangular wide surfaces positioned at both ends of a stacked electrode body in a positive/negative electrode stacking direction are regarded as the top surface and bottom surface.

Compressive stress is applied to ends of the stacked electrode body when the stacked electrode body is accommodated in a module constituent member or an exterior body such as a laminate film. It is possible for an insulating member (resin layer) to be damaged due to the compressive stress. In particular, in a case where a secondary battery is an abovementioned lithium metal battery, it is desirable for safety to be ensured, even if lithium metal reaches a melting temperature. Accordingly, also using a covering layer to cover the ends of the insulating member can be considered. However, at present sufficient consideration has not been given to a desirable disposition for the covering layer.

The present invention is made in light of the matter described above, and an object of the present invention is to provide a secondary battery having improved safety.
(1) A secondary battery that includes a multilayer body in which a negative electrode layer, a solid electrolyte layer, and a positive electrode layer are stacked in the stated order, the negative electrode layer including a negative electrode current collector layer and at least one of lithium metal or a lithium alloy, the positive electrode layer including a positive electrode current collector layer and a positive electrode active material layer that is stacked on the positive electrode current collector layer, an insulating member being disposed at an outer edge of the positive electrode active material layer in a direction orthogonal to a stacking direction of the multilayer body, a negative electrode tab and a positive electrode tab respectively extending from the negative electrode current collector layer and the positive electrode current collector layer in an X direction that is orthogonal to the stacking direction of the multilayer body, a covering layer being disposed at, from among outer edges of the insulating member in a direction orthogonal to the stacking direction, at least one outer edge in a Z direction that is orthogonal to the X direction, and a length in the X direction of the covering layer disposed on one side in the Z direction being disposed to be longer than a length of the negative electrode layer in the X direction and to include, in the X direction, both ends of the negative electrode layer in the X direction.
(2) The secondary battery according to (1), the length in the X direction of the covering layer disposed on one side in the Z direction of the insulating member being disposed to be longer than a length of the insulating member in the X direction and to include, in the X direction, both ends of the insulating member in the X direction.
(3) The secondary battery according to (2), the covering layer also being disposed at a portion of an outer edge of the insulating member in the X direction, contiguous with the covering layer disposed at one side of the insulating member in the Z direction.
(4) The secondary battery according to (3), the length in the X direction of the covering layer disposed at the outer edge in the X direction being less than or equal to 10 times the length in the Z direction of the covering layer disposed at one side of the insulating member in the Z direction.
(5) The secondary battery according to (3), the length in the X direction of the covering layer disposed at the outer edge in the X direction being less than or equal to double the length in the Z direction of the covering layer disposed at one side of the insulating member in the Z direction.
(6) The secondary battery according to any one of (1) to (5), a corner of the insulating member seen from the stacking direction being formed into a rounded shape or a chamfered shape.
(7) The secondary battery according to any one of (1) to (6), the covering layer including a resin having a dielectric breakdown resistance that is greater than or equal to 5 kV/mm and less than or equal to 50 kV/mm.
(8) The secondary battery according to any one of (1) to (7), the covering layer including a resin having a Young's modulus that is greater than or equal to 0.1 MPa and less than or equal to 70 MPa.
(9) The secondary battery according to any one of (1) to (8), the covering layer including a resin, and the resin having a weight loss percentage of less than or equal to 5% at 200° C. with respect to weight at 25° C. in a case where the resin is subjected to a rise in temperature of 3° C./min in a temperature range of 25° C. to 300° C. in simultaneous thermogravimetric/differential thermal analysis (TG-DTA).
(10) A battery module that includes the secondary battery according to any one of (1) to (9), the battery module being configured such that one side in the Z direction faces downward in a gravity direction in a state in which the battery module is used.
(11) A vehicle that includes the secondary battery according to any one of (1) to (9), the vehicle being configured such that one side in the Z direction faces downward in a gravity direction in a state in which the vehicle is used.
(12) A method of manufacturing a secondary battery having a multilayer body in which a negative electrode layer, a solid electrolyte layer, and a positive electrode layer are stacked in the stated order, the negative electrode layer including a negative electrode current collector layer and at least one of lithium metal or a lithium alloy, the positive electrode layer including a positive electrode current collector layer and a positive electrode active material layer that is stacked on the positive electrode current collector layer, an insulating member being disposed at an outer edge of the positive electrode active material layer in a direction orthogonal to a stacking direction of the multilayer body, a negative electrode tab and a positive electrode tab respectively extending from the negative electrode current collector layer and the positive electrode current collector layer in an X direction that is orthogonal to the stacking direction of the multilayer body, a covering layer being disposed at, from among outer edges of the insulating member in a direction orthogonal to the stacking direction, at least one outer edge in a Z direction that is orthogonal to the X direction, a length in the X direction of the covering layer disposed on one side in the Z direction being disposed to be longer than a length of the negative electrode layer in the X direction and to include, in the X direction, both ends of the negative electrode layer in the X direction, and the method comprising a coating step including coating a resin for forming the covering layer onto an outer edge of the insulating member from a fluid supplier and a curing step including curing the resin that has undergone the coating step.
(13) The method according to (12), the coating step, seen from the stacking direction, includes starting the coating of the resin at one end side of the insulating member that is away from a position corresponding to one end of the negative electrode layer in the X direction, and ending the coating of the resin at the other end side of the insulating member that is away from a position corresponding to the other end of the negative electrode layer in the X direction.
(14) The method according to (12), the coating step, seen from the stacking direction, includes starting the coating of the resin at one end side of the insulating member that is away from a position corresponding to one end of the insulating member in the X direction, and ending the coating of the resin at the other end side of the insulating member that is away from a position corresponding to the other end of the insulating member in the X direction.
(15) The method according to any one of (12) to (14), a viscosity of the resin in the coating step being greater than or equal to 5 Pa·s and less than or equal to 50 Pa·s.
(16) The method according to any one of (12) to (15), the resin being a UV-curable resin, and the curing step including irradiating the resin that has undergone the coating step with ultraviolet rays.

By virtue of the present invention, it is possible to provide a secondary battery having improved safety.

### BRIEF DESCRIPTION OF THE DRAWINGS

FIG. 1 is a schematic view that illustrates a structure of a Y-Z cross-section of a secondary battery according to a first embodiment;

FIG. 2 is a schematic view in which disposition of a covering layer belonging to the secondary battery according to the first embodiment is seen from a stacking direction;

FIG. 3 is a main-part enlarged view of FIG. 2;

FIG. 4 is a view that corresponds to FIG. 3 for a secondary battery according to a second embodiment;

FIG. 5 is a view that corresponds to FIG. 3 for a secondary battery according to a third embodiment;

FIG. 6 is a view that corresponds to FIG. 3 for a secondary battery according to a fourth embodiment; and

FIG. 7 is a schematic view that illustrates a coating step in a method of manufacturing the secondary battery according to the present embodiment.

### DETAILED DESCRIPTION OF THE INVENTION

### Secondary Battery

### First Embodiment

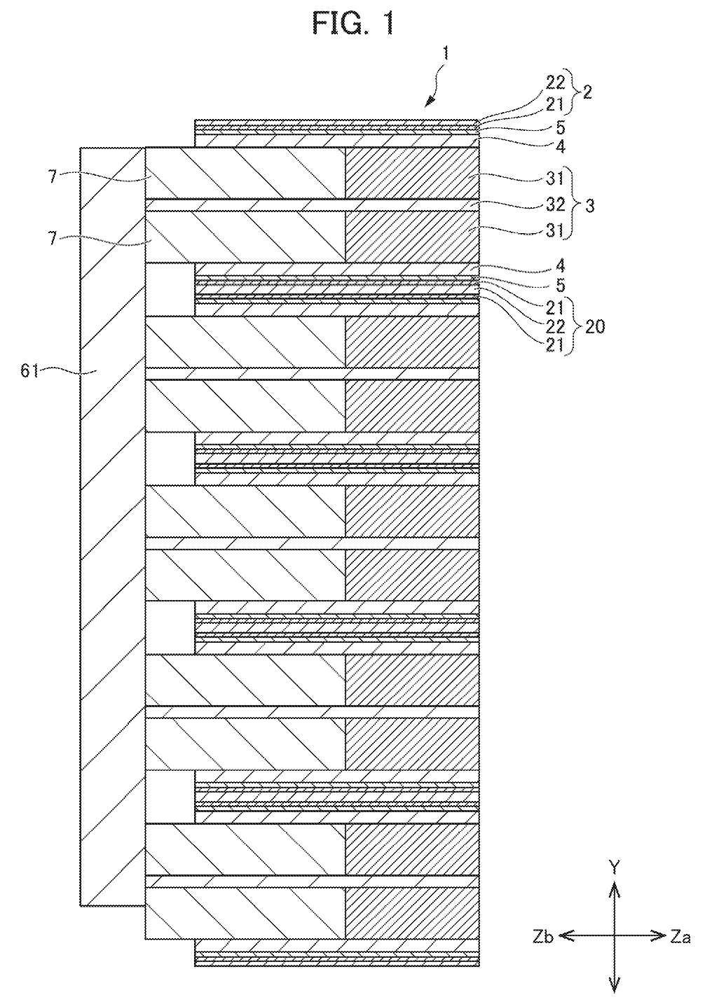

FIG. 1 is a cross-sectional view that schematically illustrates a structure of a secondary battery 1, which is manufactured using a method of manufacturing a secondary battery according to the present embodiment. In each drawing, a Y direction indicates a stacking direction of layers. An X direction indicates a direction, which is orthogonal to the stacking direction and in which current collector tabs (later-described negative electrode tabs 21a and positive electrode tabs 31a) extend. A Z direction indicates a direction that is orthogonal to the Y direction and the X direction. As illustrated in FIG. 1, the secondary battery 1 has a multilayer body in which a negative electrode layer 2 or a negative electrode layer 20, a solid electrolyte layer 4, and a positive electrode layer 3 are stacked in the stated order. An intermediate layer 5 may be optionally stacked between the solid electrolyte layer 4 and the negative electrode layer 2 or negative electrode layer 20. FIG. 1 is one example of a secondary battery according to the present invention, and a configuration of a secondary battery is not limited to the configuration in FIG. 1. For example, the number of times each layer in the secondary battery 1 is stacked is not limited to the number indicated in FIG. 1. The secondary battery 1 is a lithium metal secondary battery that has at least one of lithium metal or a lithium alloy as a negative electrode active material. Even in a case where lithium metal or lithium alloy has melted by some chance, the secondary battery 1 according to the present embodiment can favorably prevent a short circuit by means of an insulating member 7 and a covering layer 61. The secondary battery 1 is a solid-state battery that has the solid electrolyte layers 4, for example. Conversely, the secondary battery 1 may be configured by using a separator that has been impregnated with a liquid electrolyte in place of each solid electrolyte layer 4.

### Negative electrode layer

Each negative electrode layer 2 has a negative electrode current collector layer 22 and lithium metal or a lithium alloy. The lithium metal or lithium alloy functions as a negative electrode active material. A metal that can form an alloy with lithium as the abovementioned lithium metal alloy is not limited in particular, but may be one or more metals selected from the group consisting of Sn, Ag, Mg, In, Si, Al, Bi, Sb, Zn, and Cu, for example. A negative electrode active material layer 21 may be formed on the negative electrode current collector layer 22 as a layer that includes the lithium metal or lithium alloy. The negative electrode layer 2 may be an anode-free battery in which the negative electrode active material layer 21 has not been formed at a time of initial charging. In the anode-free battery, the negative electrode active material layer 21 is formed after initial charging and discharging.

The negative electrode active material layer 21 may include a material that is can be contained in a negative electrode active material layer in a secondary battery, other than that described above. This material may be a solid electrolyte, an electrically conductive aid, a binder, or the like, for example. The electrically conductive aid may be carbon black, natural graphite, carbon fibers, carbon nanotubes, or the like. The solid electrolyte and the binder may be similar to a solid electrolyte material and binder that are contained in a solid electrolyte layer 4, which is described below.

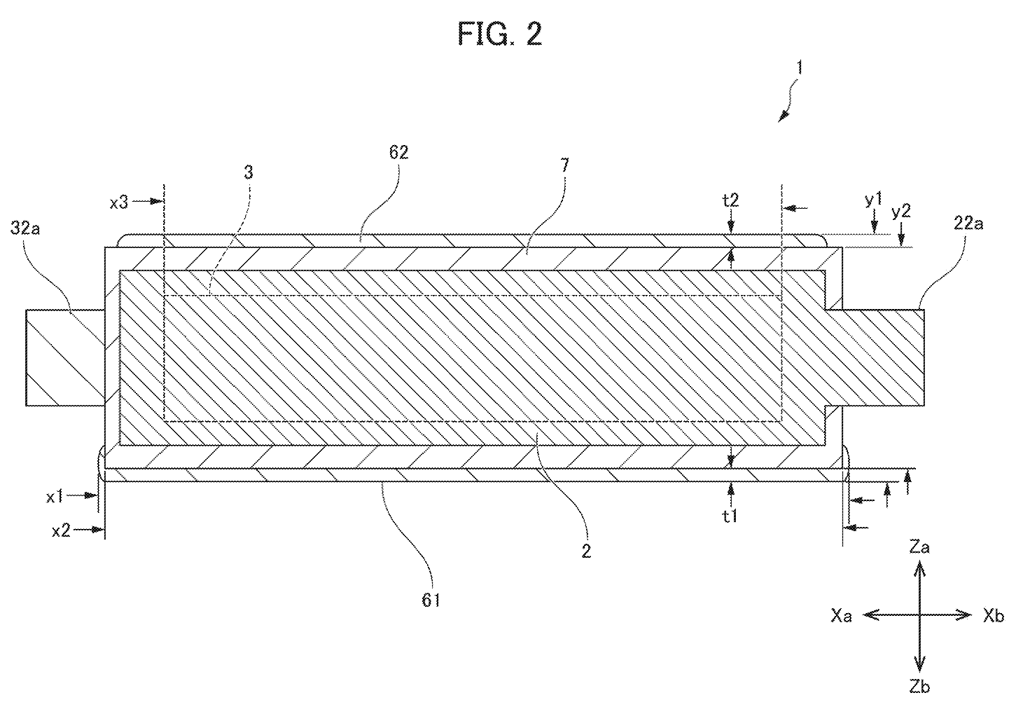

The negative electrode current collector layer 22 is not limited in particular, but can be configured from copper, nickel, stainless steel, or the like. The shape of the negative electrode current collector layer 22 may be foil-shaped, plate-shaped, mesh-shaped, shaped like non-woven fabric, foam-shaped, or the like, for example. A portion of the negative electrode current collector layer 22 extends in an Xb direction in FIG. 2 and configures a negative electrode current collector tab (negative electrode tab) 22a. The negative electrode current collector tab 22a may be a member that is a separate body from the negative electrode current collector layer 22 and is joined to the negative electrode current collector layer 22. In the present specification and the claims, it is assumed that the negative electrode current collector tab 22a is not included in the concept of a negative electrode layer.

Apart from the negative electrode layer 2, a negative electrode layer may, for example, be a result of two negative electrode active material layers 21 being respectively stacked on the two surfaces of one negative electrode current collector layer 22, as in the negative electrode layer 20 illustrated in FIG. 1. Negative electrode layers are generically referred to as negative electrode layers 2 in the following description.

### Positive electrode layer

Each positive electrode layer 3 has a positive electrode active material layer 31 and a positive electrode current collector layer 32. In the present embodiment, the positive electrode layer 3 has a configuration resulting from respectively stacking two positive electrode active material layers 31 on the two surfaces of one positive electrode current collector layer 32. Conversely, the configuration of a positive electrode layer 3 is not limited to that described above, and the positive electrode layer 3 may have a configuration in which one positive electrode active material layer 31 is stacked on a single surface of one positive electrode current collector layer 32.

The positive electrode active material layer 31 is not limited in particular and can be configured by a material that can be used as a positive electrode active material in a secondary battery. An example of a positive electrode active material that configures the positive electrode active material layer 31 may be: layered positive electrode active material particles such as LiCoO₂, LiNiO₂, LiCoₓNi_{y}Mn_{z}O₂ (x + y + z = 1), LiVO₂, or LiCrO₂; a spinel-type positive electrode active material such as LiMn₂O₄, Li(Ni_{0.25}Mn_{0.75})₂O₄, LiCoMnO₄, or Li₂NiMn₃O₈; an olivine-type positive electrode active material such as LiCoPO₄, LiMnPO₄, or LiFePO₄; a solid solution oxide (Li₂MnO₃-LiMO₂ (M= Co, Ni, or the like)); an electrically conductive polymer such as polyaniline or polypyrrole; a sulfide such as Li₂S, CuS, an Li-Cu-S compound, TiS₂, FeS, MoS₂, or an Li-Mo-S compound; a mixture of sulfur and carbon; or the like. The abovementioned positive electrode active material may use one of the abovementioned materials, or may be configured by being made from two or more of the abovementioned materials.

Apart from the above, the positive electrode active material layer 31 may include a material that can be contained in a positive electrode active material layer for a secondary battery, such as a solid electrolyte, an electrically conductive aid, or a binder. The abovementioned material may be similar to material that can be contained in the negative electrode active material layer 21.

The positive electrode current collector layer 32 is not limited in particular, but can be configured from aluminum, stainless steel, electrically conductive carbon (such as graphite or carbon nanotubes), or the like, for example. The shape of the positive electrode current collector layer 32 may be foil-shaped, plate-shaped, mesh-shaped, shaped like non-woven fabric, foam-shaped, or the like, for example. A portion of the positive electrode current collector layer 32 extends in an Xa direction in FIG. 2 and configures a positive electrode current collector tab (positive electrode tab) 32a.

### Solid electrolyte layer

In the present embodiment, each solid electrolyte layer 4 is stacked between an intermediate layer 5 and a positive electrode layer 3. FIG. 1 illustrates a state in which each single solid electrolyte layer 4 is stacked between an intermediate layer 5 and a positive electrode layer 3, but the number of solid electrolyte layers 4 stacked between an intermediate layer 5 and a positive electrode layer 3 is not limited to one. For example, there may be two solid electrolyte layers 4 that are stacked therebetween, or there may be three or more solid electrolyte layers 4 that are stacked therebetween. In a case where the secondary battery 1 lacks intermediate layers 5, each solid electrolyte layer 4 may be stacked between a negative electrode layer 2 and a positive electrode layer 3. Each solid electrolyte layer 4 includes a solid electrolyte material. The solid electrolyte material is not limited in particular and, for example, may be: an inorganic solid electrolyte such as a sulfide solid electrolyte material, an oxide solid electrolyte material, a halide solid electrolyte, or a lithium-containing salt; a polymer-based solid electrolyte such as polyethylene oxide; or the like, for example. One of the abovementioned solid electrolyte materials may be used, or two or more of the abovementioned solid electrolyte materials may be used in combination.

Apart from the abovementioned solid electrolyte material, the solid electrolyte layer 4 may include a binder. The binder may be a fluorine resin, a nitrile-based polymer, a polyester-based polymer, an acrylic acid-based polymer, a cellulosic polymer, a styrene-based polymer, a styrene-butadiene-based polymer, a vinyl acetate-based polymer, a urethane-based polymer, or the like, for example. One of the abovementioned binders may be used, or two or more of the abovementioned binders may be used in combination.

### Intermediate layer

Each intermediate layer 5 is optionally disposed between a negative electrode layer 2 and a solid electrolyte layer 4. The intermediate layer 5 has lithium-ion conductivity. The intermediate layer 5 has a function for causing lithium metal (dendrite) to precipitate uniformly. The number of intermediate layers 5 is not limited in particular.

Material that configures the intermediate layer 5 is not limited in particular, but may be a metal that can form an alloy with lithium, amorphous carbon, or the like, for example. A metal that can form an alloy with lithium may be tin (Sn), silicon (Si), zinc (Zn), magnesium (Mg), gold (Au), platinum (Pt), palladium (Pd), silver (Ag), aluminum (Al), bismuth (Bi), antimony (Sb), or the like, for example. These metals may be composited with carbon. A metal that can form an alloy with lithium may be nanoparticles. The amorphous carbon may be: carbon black such as acetylene black, furnace black, or Ketjen black; coke; activated carbon; or the like, for example. The amorphous carbon may be easily graphitizable carbon (soft carbon), or may be carbon that is difficult to graphitize (hard carbon), carbon nanotubes (CNT), fullerene, or graphene. Apart from the material described above, the intermediate layer 5 may include a binder. As the binder, it is possible to use a material that is similar to a binder that can be included in the solid electrolyte layer 4.

### Insulating member

Insulating members 7 are provided at outer edges in directions orthogonal to the direction in which the positive electrode active material layers 31 are stacked (directions including the Z direction and the X direction). By virtue of the insulating members 7, it is possible to ensure creepage distances between negative electrodes and positive electrodes, and suppress a short circuit of the secondary battery 1 in a structural fashion. In addition, it is possible to suppress the occurrence of cracks due to a change in volume in conjunction with repeated charging and discharging, and it is also possible to suppress short circuits due to cracks.

In the present embodiment, each insulating member 7 is disposed so as to cover the outer edges of two positive electrode active material layers 31 that are formed on two surfaces of a positive electrode current collector layer 32, as illustrated in FIG. 1. The shape of such an insulating member 7 is not limited if provided at the outer edges of positive electrode active material layers 31, but may be a frame as illustrated in FIG. 2. Each insulating member 7 is in contact with a portion of a stacking surface of a positive electrode current collector layer 32, and may have a gap through which a positive electrode current collector tab 32a extends.

A material that configures an insulating member 7 may be a material that has insulation properties and is not a semiconductor or an electrical conductor and is not limited in particular, but may be an insulating oxide such as alumina, a resin such as polyvinylidene fluoride (PVDF), or a rubber such as styrene-butadiene rubber (SBR), for example.

As illustrated in FIG. 1, ends of the insulating member 7 in directions orthogonal to the stacking direction are disposed outside of ends of the negative electrode layer 2 and solid electrolyte layer 4. In other words, the insulating member 7 has a shape that protrudes from the multilayer body. Accordingly, by means of the insulating members 7, it is possible to protect the multilayer body from external force, and it is possible to improve the safety of the secondary battery 1. In addition, a covering layer is disposed at the outer edge of the insulating member 7 in the Z direction in order to ensure insulation properties for the secondary battery 1 and further improve safety, even in a case where the insulating member 7 is damaged.

### Covering layer

It is essential for a covering layer to be disposed on at least one outer edge of the insulating members 7 in the Z direction. In contrast, a covering layer may be disposed on both outer edges of the insulating members 7 in the Z direction, as indicated by reference symbols 61 and 62 in FIG. 2. In the following description, a covering layer that is essential to be disposed is described as a covering layer 61, and a covering layer that may be optionally disposed is described as a covering layer 62. Unless otherwise specified, the configuration of the covering layer 61 can also be employed for the covering layer 62.

The covering layer 61 desirably has insulation properties, and includes a resin having a dielectric breakdown resistance that is greater than or equal to 5 kV/mm and less than or equal to 50 kV/mm, for example.

The covering layer 61 desirably includes a resin having a Young's modulus that is greater than or equal to 0.1 MPa and less than or equal to 70 MPa.

The covering layer 61 desirably has a weight loss percentage of 5% or less of the weight thereof at 200° C. compared to the weight thereof at 25° C. in a case of being subjected to a rise in temperature of 3° C./min in a temperature range of 25° C. to 300° C. in simultaneous thermogravimetric/differential thermal analysis (TG-DTA). As a result, the safety of the secondary battery 1 can be further improved.

The covering layer 61 is desirably configured by a UV-curable resin. As a result, it is possible to easily form the covering layer 61.

The covering layer 61 is desirably disposed so as to cover at least a portion of the ends of all of the insulating members 7 in the Z direction, as illustrated in FIG. 1. It is desirable for the covering layer 61 to be formed so as to be connected at at least one location and joined together as a whole. As a result, it is possible to suppress stacking misalignment for the multilayer body.

FIG. 2 is a schematic view in which a disposition situation for the covering layer 61 is viewed from the stacking direction. As illustrated in FIG. 2, disposition is performed such that a length x1 of the covering layer 61 in the X direction is longer than a length x3 of a negative electrode layer 2 in the X direction and includes, in the X direction, both ends of the negative electrode layer 2 in the X direction. In this case, it is desirable to install or use the secondary battery 1 such that a Zb direction faces downward in a gravity direction. As a result, using the covering layer 61, it is possible to prevent lithium metal from coming into contact with the positive electrode layer 3, even in a case where, by some chance, an insulating member 7 is damaged and lithium metal has melted. Accordingly, it is possible to improve the safety of the secondary battery 1.

In the present embodiment, the covering layer 61 is disposed such that the length x1 in the X direction is longer than a length x2 of an insulating member 7 in the X direction, and includes, in the X direction, both ends of the insulating member 7 in the X direction. As a result, it is possible to further improve the safety of the secondary battery 1. In addition, in the present embodiment, a covering layer is also provided to a portion of the outer edge of the insulating member 7 in the X direction so as to be contiguous with the covering layer 61. This covering layer is formed integrally with the covering layer 61. As a result, it is possible to dispose covering layers such that both ends of each insulating member 7 in the X direction are reliably included in the X direction.

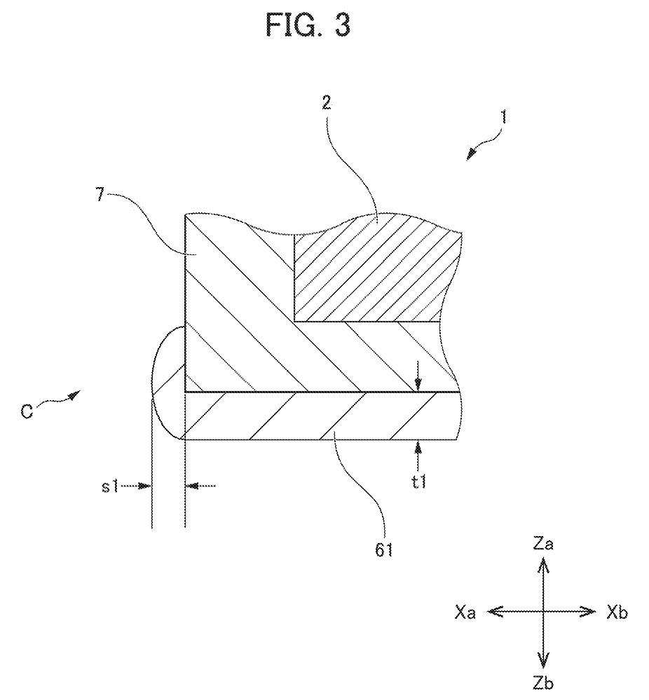

FIG. 3 is a view in which the vicinity of a corner C of an insulating member 7 in FIG. 2 is enlarged. It is desirable for a length s1 in the Xa direction of the covering layer that is disposed at a portion of an outer edge of the insulating member 7 in the Xa direction to be less than or equal to 10 times a length t1 of the covering layer 61, which is disposed at the outer edge of the insulating member 7 in the Zb direction. Note that the length s1 in the X direction of the covering layer disposed at the portion of the outer edge of the insulating member 7 in the Xa direction means the length from the end of the insulating member 7 in the Xa direction to the end of the covering layer 61 in the Xa direction, as illustrated in FIG. 3. The length s1 satisfies the above requirements, whereby it is possible to improve the energy density of the secondary battery 1. In addition, it becomes easier to ensure a space for disposing a constituent member of a secondary battery module that includes the secondary battery 1. In light of the perspectives described above, it is desirable for the length s1 to be less than or equal to double the length t1. Note that, although illustration is omitted, it is desirable for a covering layer similar to that described above to be disposed at the outer edge of the insulating member 7 in the Xb direction.

In addition, the covering layer 62 may be also disposed at the other outer edge of the insulating member 7 in the Z direction. The covering layer 62 may satisfy the above-described conditions for the disposition and size of the covering layer 61, but does not need to satisfy the conditions. A length t2 of the covering layer 62 in the Z direction may be similar to the length t1 of the covering layer 61 in the Z direction, or may be different from the length t1. The safety of the secondary battery 1 can be further improved by disposing the covering layer 62 that satisfies the above-described conditions for the covering layer 61. Conversely, from a perspective of emphasizing the energy density of the secondary battery 1, it is also possible for the covering layer 62 to not satisfy the above-described conditions for the covering layer 61, or to not dispose the covering layer 62.

### Battery Module

A battery module according to the present embodiment is configured by stacking a plurality of the secondary batteries 1 described above. The battery module has a pair of end plates that are disposed at two ends of the plurality of secondary batteries 1 in the stacking direction, for example. Apart from that described above, the battery module may have a configuration that is publicly known as a secondary battery module and includes a cooling apparatus such as a cooling plate or a water jacket, a heat transfer member, a cushion material, a heat-insulating material, or the like.

The battery module, in an installation state, is desirably configured such that one side in the Z direction at which the above-described covering layer 61 is disposed for each of the plurality of secondary batteries 1 (the Zb direction in each drawing) faces downward in the gravity direction. As a result, it is possible to obtain the above-described effects for the secondary battery 1. Note that the abovementioned installation state means a state in which the battery module is charging/discharging with respect to an external unit and is thus ordinarily used, and does not mean a state of being conveyed or the like.

### Vehicle

A vehicle according to the present embodiment includes the secondary battery 1 described above. The secondary battery 1 may be mounted to the vehicle in an aspect of the battery module described above. Such a vehicle may be a so-called electric vehicle (EV) that lacks an engine, or may be a so-called plug-in hybrid electric vehicle (PHEV) that has an engine, for example.

The vehicle, in an installation state, is desirably configured such that one side in the Z direction at which the above-described covering layer 61 is disposed for each of one or more secondary batteries 1 (the Zb direction in each drawing) faces downward in the gravity direction. As a result, it is possible to obtain the above-described effects for the secondary battery 1. Note that downward in the gravity direction in the installation state for the vehicle means a ground-contacting surface side (installation surface side) for the vehicle, for example, and does not mean downward for a state of being conveyed or the like.

### Method of Manufacturing Secondary Battery

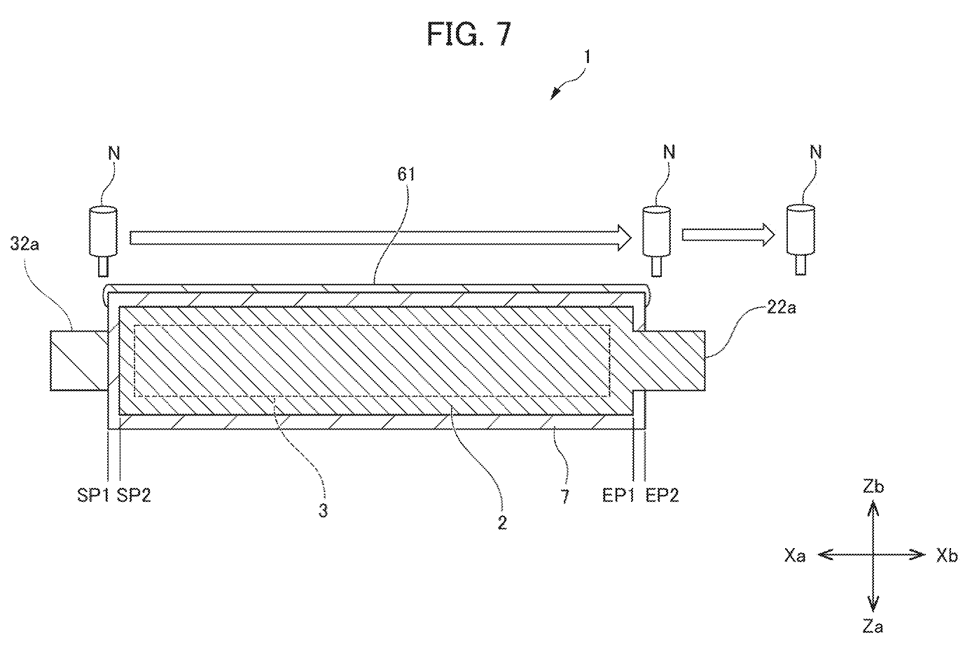

Using FIG. 7, description is given below regarding a method of manufacturing the secondary battery 1 according to the embodiment described above. The method of manufacturing the secondary battery 1 according to the present embodiment includes a coating step for coating an outer edge of the insulating member 7 with a resin for forming the covering layer from a nozzle (a fluid supplier) N, and a curing step for curing resin that has undergone the coating step. As a result, it is possible to easily form the covering layer.

FIG. 7 is a schematic view that illustrates the coating step for applying the covering layer 61, which is disposed at one outer edge of an insulating member 7 in the Z direction (Zb direction). Note that, before the coating step, a multilayer body is formed by forming and stacking each above-described layer of the secondary battery 1 apart from the covering layer 61. Conditions for manufacturing the multilayer body are not limited in particular. As illustrated in FIG. 7, in a case of applying the covering layer 61, the multilayer body is placed such that the Zb direction of the multilayer body becomes upward in the gravity direction. The nozzle N that is filled with the abovementioned resin is disposed at one side of the outer edge of the insulating member 7 in the Z direction (for example, the positive electrode current collector tab 32a side as illustrated in FIG. 7), coating is started, the nozzle N discharges the resin while the nozzle N is caused to move to the other side (for example, the negative electrode current collector tab 22a side), and the coating ends.

A coating start position in the coating step is, seen from the stacking direction, desirably at one end side of the insulating member 7 (for example, the positive electrode current collector tab 32a) away from a position corresponding to one end of the insulating member 7 in the X direction (an end SP1 in the Xa direction). Similarly, a coating end position is desirably at the other end side of the insulating member 7 (for example, the negative electrode current collector tab 22a side) away from a position corresponding to the other end of the insulating member 7 in the X direction (an end EP2 in the Xb direction). As a result, it is possible to easily form the covering layer 61 with reference to the position of the insulating member 7. After the coating ends, the nozzle N may be controlled such that the nozzle N is released from the coating end position.

In a case of forming a covering layer 61c according to a later-described fourth embodiment, the coating start position in the coating step may be, seen from the stacking direction, on one end side of the negative electrode layer 2 (for example, the positive electrode current collector tab 32a side) away from a position corresponding to one end of the negative electrode layer 2 in the X direction (an end SP2 in the Xa direction). Similarly, the coating end position may be on the other end side of the negative electrode layer 2 (for example, the negative electrode current collector tab 22a side) away from a position corresponding to the other end of the negative electrode layer 2 in the X direction (an end EP1 in the Xb direction).

The fluid supplier used in the coating step is not limited in particular, and it is possible to use a slit nozzle or the like. As a coating apparatus provided with such a nozzle, it is possible to use a publicly known coating apparatus such as a die coater. In addition, a step such as for shaping or using a squeegee or the like to spread uncured resin may be provided after approximate coating by the fluid supplier in the coating step.

It is desirable for a resin (an uncured resin composition) for forming a covering layer to have a viscosity that is greater than or equal to 5 Pa·s and less than or equal to 50 Pa·s. As a result, it is less likely for drips to arise even if a resin composition is directly discharged onto an outer edge of an insulating member 7 and coating is easily performed at a desired position. Therefore, it is possible to easily perform coating using a nozzle. The abovementioned viscosity may be viscosity at 25° C.

It is desirable for a resin for forming a covering layer to be a UV-curable resin. As a result, it is possible to easily form the covering layer without requiring thermosetting. As a UV-curable resin, it is possible to use a publicly known resin composition that includes, inter alia, a monomer or oligomer having a radical polymerizable functional group, a photopolymerization initiator, and an additive or solvent if necessary. For example, it is possible to use an acrylic resin, a silicone resin, an olefin resin, or the like as the UV-curable resin.

In a case where the resin is a UV-curable resin, the curing step includes curing the UV-curable resin that has undergone the coating step by irradiating the UV-curable resin with ultraviolet rays. A UV irradiation apparatus used in the curing step is not limited in particular. It is possible to use a publicly known UV irradiation apparatus that has a publicly known LED lamp, mercury lamp, metal halide lamp, or the like. The wavelength and cumulative quantity of light for ultraviolet rays that are irradiated can be selected, as appropriate, in accordance with the type of UV-curable resin used and are not limited in particular, but it is possible to set the wavelength to be greater than or equal to 345 nm and less than or equal to 385 nm, and the cumulative quantity of light to be less than or equal to 21000 mJ/cm², for example.

As the abovementioned resin, it may be that a resin other than a UV-curable resin, such as a thermosetting resin or an anionic curable resin, for example, is used. In this case, a curing method that corresponds to the type of resin used would be used in the curing step.

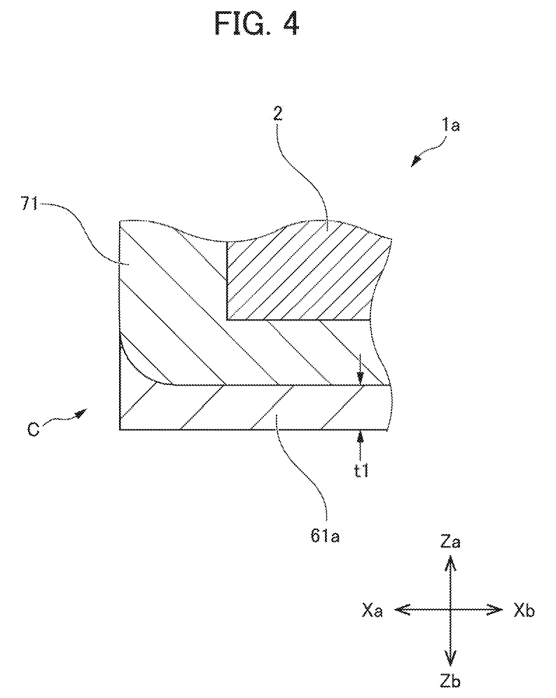

Description was given above regarding a first embodiment of the present invention. Description of other embodiments of the present invention is given below. Regarding configurations similar to those of the first embodiment described above, the same reference symbols are added to drawings and description is omitted. Note that, in FIGS. 4-6 described below, the vicinity of a corner C of an insulating member in the Xa direction is illustrated similarly to FIG. 3, but the vicinity of a corner C of the insulating member in the Xb direction also has a similar configuration.

### Second Embodiment

FIG. 4 is a schematic view that corresponds to FIG. 3 and illustrates a disposition for a covering layer 61a in a secondary battery 1a according to the present embodiment. Similarly to the covering layer 61, the covering layer 61a is disposed, as essential, at one outer edge of an insulating member 71 in the Z direction. As illustrated in FIG. 4, for an insulating member 71 according to the present embodiment, a corner C seen from a stacking direction has a rounded shape. As a result, in a case of using coating to form the covering layer 61a, it is possible to easily form a covering layer that is contiguous with the covering layer 61a at a portion of the insulating member 71 in the X direction. The insulating member 71 may have a chamfered shape in place of the abovementioned rounded shape.

The covering layer that is contiguous with the covering layer 61a and is disposed at a portion of the insulating member 71 in the X direction is formed so that the end thereof in the Xa direction follows the Z direction. Such a covering layer can be formed by using a mold or by cutting. By virtue of the covering layer, it is possible to further improve the energy density of the secondary battery 1a. In addition, it is possible to make it easier to ensure a space for disposing a constituent member of a secondary battery module that includes the secondary battery 1a.

### Third Embodiment

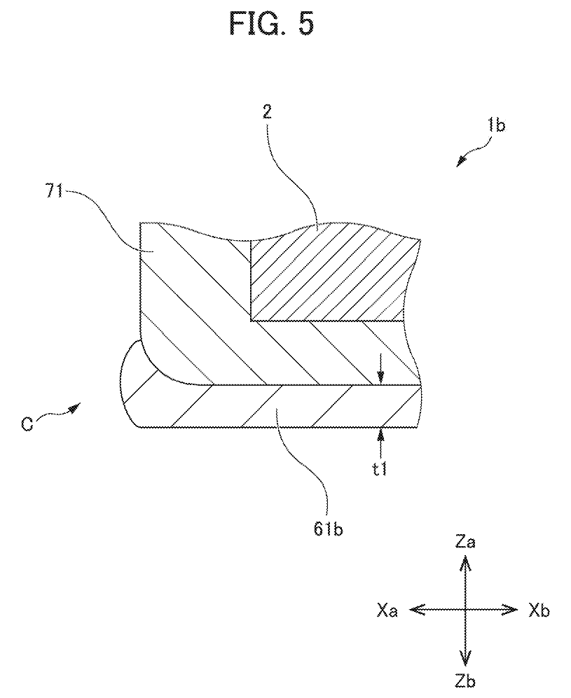

FIG. 5 is a schematic view that corresponds to FIG. 3 and illustrates a disposition for a covering layer 61b in a secondary battery 1b according to the present embodiment. Similarly to the covering layer 61, the covering layer 61b is disposed, as essential, at one outer edge of an insulating member 71 in the Z direction. The configuration of the insulating member 71 is similar to that in the second embodiment.

The covering layer 61b differs to that in the second embodiment and the end thereof in the Xa direction is disposed outside of the end of the insulating member 71 in the Xa direction. Similarly to in the first embodiment, a covering layer is also disposed at a portion of an outer edge of the insulating member 71 in the Xa direction. This covering layer is formed integrally with the covering layer 61b. For example, the covering layer 61b is formed by coating, and the end of the coated covering layer 61b in the Xa direction is formed without being shaped by a mold and without cutting. Accordingly, it is possible to simplify a process for manufacturing the secondary battery 1b more than the second embodiment. In addition, the corner C of the insulating member 71 has a rounded shape or a chamfered shape. Therefore, in a case of using coating to form the covering layer 61b, a portion of a coated resin composition is disposed in a rounded shape or a chamfered shape. Accordingly, in comparison to the first embodiment in which the corner C is substantially right-angled, it is easier to reduce the length, in the X direction, of the covering layer disposed at the outer edge of the insulating member 71 in the Xa direction. Accordingly, it is possible to improve the energy density of the secondary battery 1b.

### Fourth Embodiment

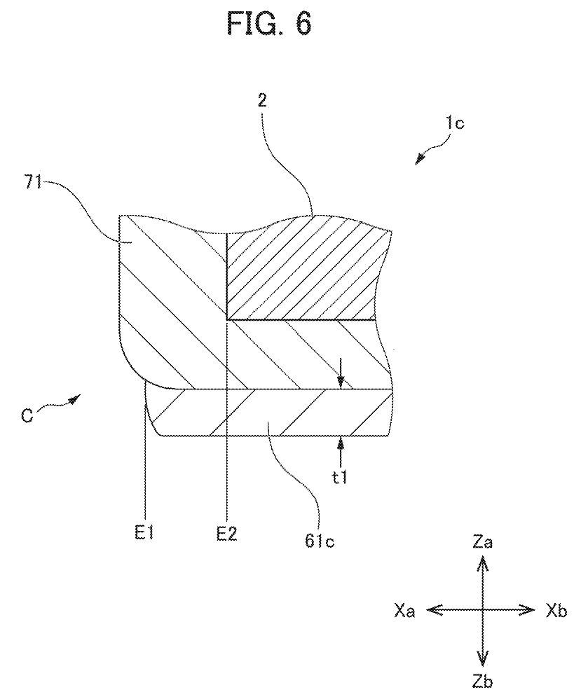

FIG. 6 is a schematic view that corresponds to FIG. 3 and illustrates a disposition for a covering layer 61c in a secondary battery 1c according to the present embodiment. Similarly to the covering layer 61, the covering layer 61C is disposed, as essential, at one outer edge of an insulating member 71 in the Z direction. The configuration of the insulating member 71 is similar to that in the second embodiment.

In the present embodiment, a covering layer is not disposed at a portion of an outer edge of the insulating member 71 in the Xa direction, differing to in the first embodiment. Furthermore, an end position E1 of the covering layer 61c in the Xa direction is on the Xb direction side of the end position of the insulating member 71 in the Xa direction. However, the end position E1 is on the Xa direction side of an end position E2 of the negative electrode layer 2 in the Xa direction. Although illustration is omitted, the end position of the covering layer 61c in the Xb direction is similar. In other words, the length of the covering layer 61c in the X direction is shorter than the length of the insulating member 71 in the X direction. In addition, the covering layer 61c is disposed so as to be longer than the length of the negative electrode layer 2 in the X direction and to include, in the X direction, both ends of the negative electrode layer 2 in the X direction. By virtue of the above-described covering layer 61c it is also possible to obtain an effect of preventing lithium metal from coming into contact with the positive electrode layer 3. In addition, in comparison to other embodiments, it is possible to reduce the amount of the covering layer, and thus it is possible to improve the energy density of the secondary battery 1c.

Description was given above regarding desirable embodiments of the present invention. The present invention is not limited to the embodiments described above, and can be changed, as appropriate, within a scope that does not inhibit the effect of the present invention.

### EXPLANATION OF REFERENCE NUMERALS

1 Secondary battery
2, 20 Negative electrode layer
22 Negative electrode current collector layer
22a Negative electrode tab (negative electrode current collector tab)
3 Positive electrode layer
31 Positive electrode active material layer
32 Positive electrode current collector layer
32a Positive electrode tab (positive electrode current collector tab)
4 Solid electrolyte layer
61 Covering layer
7 Insulating member

What is claimed is:

1. A secondary battery comprising a multilayer body in which a negative electrode layer, a solid electrolyte layer, and a positive electrode layer are stacked in the stated order, wherein
the negative electrode layer includes a negative electrode current collector layer and at least one of lithium metal or a lithium alloy,
the positive electrode layer includes a positive electrode current collector layer and a positive electrode active material layer that is stacked on the positive electrode current collector layer, an insulating member being disposed at an outer edge of the positive electrode active material layer in a direction orthogonal to a stacking direction of the multilayer body,
a negative electrode tab and a positive electrode tab respectively extend from the negative electrode current collector layer and the positive electrode current collector layer in an X direction that is orthogonal to the stacking direction of the multilayer body,
a covering layer is disposed at, from among outer edges of the insulating member in a direction orthogonal to the stacking direction, at least one outer edge in a Z direction that is orthogonal to the X direction, and
a length in the X direction of the covering layer disposed on one side in the Z direction is disposed to be longer than a length of the negative electrode layer in the X direction and to include, in the X direction, both ends of the negative electrode layer in the X direction.

2. The secondary battery according to claim 1, wherein the length in the X direction of the covering layer disposed on one side in the Z direction of the insulating member is disposed to be longer than a length of the insulating member in the X direction and to include, in the X direction, both ends of the insulating member in the X direction.

3. The secondary battery according to claim 2, wherein the covering layer is also disposed at a portion of an outer edge of the insulating member in the X direction, contiguous with the covering layer disposed at one side of the insulating member in the Z direction.

4. The secondary battery according to claim 3, wherein the length in the X direction of the covering layer disposed at the outer edge in the X direction is less than or equal to 10 times the length in the Z direction of the covering layer disposed at one side of the insulating member in the Z direction.

5. The secondary battery according to claim 3, wherein the length in the X direction of the covering layer disposed at the outer edge in the X direction is less than or equal to double the length in the Z direction of the covering layer disposed at one side of the insulating member in the Z direction.

6. The secondary battery according to claim 3, wherein a corner of the insulating member seen from the stacking direction is formed into a rounded shape or a chamfered shape.

7. The secondary battery according to claim 1, wherein the covering layer includes a resin having a dielectric breakdown resistance that is greater than or equal to 5 kV/mm and less than or equal to 50 kV/mm.

8. The secondary battery according to claim 1, wherein the covering layer includes a resin having a Young's modulus that is greater than or equal to 0.1 MPa and less than or equal to 70 MPa.

9. The secondary battery according to claim 1, wherein the covering layer includes a resin, and the resin has a weight loss percentage of less than or equal to 5% at 200° C with respect to weight at 25° C in a case where the resin is subjected to a rise in temperature of 3° C/min in a temperature range of 25° C to 300° C in simultaneous thermogravimetric/differential thermal analysis (TG-DTA).

10. A battery module comprising the secondary battery according to claim 1,
wherein the battery module is configured such that one side in the Z direction faces downward in a gravity direction in a state in which the battery module is used.

11. A vehicle comprising the secondary battery according to claim 1,
wherein the vehicle is configured such that one side in the Z direction faces downward in a gravity direction in a state in which the vehicle is used.

12. A method of manufacturing a secondary battery having a multilayer body in which a negative electrode layer, a solid electrolyte layer, and a positive electrode layer are stacked in the stated order, wherein
the negative electrode layer includes a negative electrode current collector layer and at least one of lithium metal or a lithium alloy,
the positive electrode layer includes a positive electrode current collector layer and a positive electrode active material layer that is stacked on the positive electrode current collector layer, an insulating member being disposed at an outer edge of the positive electrode active material layer in a direction orthogonal to a stacking direction of the multilayer body,
a negative electrode tab and a positive electrode tab respectively extend from the negative electrode current collector layer and the positive electrode current collector layer in an X direction that is orthogonal to the stacking direction of the multilayer body,
a covering layer is disposed at, from among outer edges of the insulating member in a direction orthogonal to the stacking direction, at least one outer edge in a Z direction that is orthogonal to the X direction,
a length in the X direction of the covering layer disposed on one side in the Z direction is disposed to be longer than a length of the negative electrode layer in the X direction and to include, in the X direction, both ends of the negative electrode layer in the X direction, and
the method comprises a coating step including coating a resin for forming the covering layer onto an outer edge of the insulating member from a fluid supplier and a curing step including curing the resin that has undergone the coating step.

13. The method according to claim 12, wherein the coating step, seen from the stacking direction, includes starting the coating of the resin at one end side of the insulating member that is away from a position corresponding to one end of the negative electrode layer in the X direction, and ending the coating of the resin at the other end side of the insulating member that is away from a position corresponding to the other end of the negative electrode layer in the X direction.

14. The method according to claim 12, wherein the coating step, seen from the stacking direction, includes starting the coating of the resin at one end side of the insulating member that is away from a position corresponding to one end of the insulating member in the X direction, and ending the coating of the resin at the other end side of the insulating member that is away from a position corresponding to the other end of the insulating member in the X direction.

15. The method according to claim 12, wherein a viscosity of the resin in the coating step is greater than or equal to 5 Pa·s and less than or equal to 50 Pa·s.

16. The method according to claim 12, wherein
the resin is a UV-curable resin, and
the curing step includes irradiating the resin that has undergone the coating step with ultraviolet rays.
